(19) United States
(12) Patent Application Publication
(10) Pub. No.: US 2009/0042565 A1
(43) Pub. Date: Feb. 12, 2009

(54) CONNECTION POINT TRIGGERED SCANNING FOR POSITIONING RADIOS

(75) Inventors: Marion Hermersdorf, Helsinki (FI); Antti Virolainen, Helsinki (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/836,443

(22) Filed: Aug. 9, 2007

(51) Int. Cl. H04Q 7/20

(52) U.S. Cl. 455/434; 455/456.1

(57) ABSTRACT

A system for automatically controlling the scanning frequency of a radio based positioning application in a wireless communication device (WCD) based on the connection point information of the WCD. The connection point information may be utilized to identify if the WCD is near a positioning-enabled environment. Scanning may be activated, or the scanning frequency may be increased, when the WCD is in an environment that is served by certain connection points (e.g., connection points located in a city). On the other hand, when the WCD is in an environment that is not served by certain connection points (e.g., a rural area), scanning may be stopped or the scanning frequency may be reduced to conserve power in the mobile device.

### BACKGROUND OF THE INVENTION

1. Field of Invention

The present invention relates to the controlling of an application in a wireless communication device, and more specifically to adjusting the scanning frequency of a radio-based positioning application based on the current connection point or Cell ID information.

2. Background

While wireless communication devices (WCDs) were perhaps viewed by many as a luxury when first introduced into the marketplace, they are today viewed by our society as very important, useful, and convenient tools. A large segment of society now carries their wireless communication devices with them wherever they go. These devices include, for example, mobile telephones, Personal Digital Assistants (PDAs), laptop/notebook computers, and the like. The popularity of these devices and the ability to communicate wirelessly has spawned a multitude of new wireless systems, devices, protocols, etc. Consumer demand for advanced wireless functions and capabilities has also fueled a wide range of technological advances in the utility and capabilities of wireless devices. Wireless communication devices not only allow voice communication, but also facilitate messaging, multimedia communications, e-mail, Internet browsing, and access to a wide range of wireless applications and services.

More recently, manufacturers have also began to incorporate various resources for providing enhanced functionality in WCDs (e.g., components and software for performing close-proximity wireless information exchanges). Sensors and/or scanners may be used to read visual or electronic information into a device. A transaction may involve a user holding their WCD in proximity to a target, aiming their WCD at an object (e.g., to take a picture) or sweeping the device over a printed tag or document. Machine-readable technologies such as radio frequency identification (RFID), Infra-red (IR) communication, optical character recognition (OCR) and various other types of visual, electronic and magnetic scanning are used to quickly input desired information into the WCD without the need for manual entry by a user.

Advancements in wireless communication technology, such as those previously described, have created a desire in the public for the increased use of wireless communications in everyday tasks. These tasks may be facilitated by programs on the device that may communicate via a multitude of wireless communication mediums. However, in some cases these applications or services might only be available for use on a wireless communication device when the user is in or near a particular location or environment that supports the desired functionality. Radio based positioning is an example of one such application which may be beneficial to the user in positioning-enabled environments, and is of little use in areas which are not positioning-enabled.

Radio based positioning is based on scanning and detecting fixed radio beacons or stations (e.g., wireless access points communicating via short-range wireless communication like WLAN, Bluetooth™, RFID, Wibree, etc.) in a positioning-enabled environment. In order to provide accurate location determination, the scanning may be frequently performed at a regular interval. Such continual scanning may deplete a battery in a mobile device. However, radio based positioning is not universally supported (e.g., some locations are not positioning-enabled environments because this information is not available). Thus, when a user enters or leaves a positioning-enabled environment, activation/deactivation of radio based positioning applications must be controlled manually. A major problem in the relying on manual control is unintentional power expenditure in battery-driven devices. A user may be unintentionally expending stored energy due to not disabling the radio based positioning application or service when not in use.

In view of the above, what is needed is a system for automatically detecting a positioning-enabled environment, and controlling a positioning-related application in a wireless communication device depending on a device's presence in a positioning-enabled environment.

### SUMMARY OF INVENTION

The present invention may include at least a method, apparatus, system and computer program for automatically controlling a radio based positioning application, including both hardware and software resources, depending on a connection point or Cell ID information of a wireless communication device (WCD).

In accordance with at least one embodiment of the present invention, the WCD may activate scanning or increase a scanning frequency in support of a position determination application when the WCD is near a positioning-enabled environment, and may deactivate or decrease the scanning frequency when the WCD is not in a positioning-enabled environment.

Further, the WCD may maintain a list that may be accessed whenever the device near to, or departing from, a positioning-enabled environment. This list may store information such as Cell ID's, IP addresses, MAC addresses, etc. that identify resources within positioning-enabled environments. Further, this information may be created and/or managed by the WCD based on encountered beacons, stations, access points, etc. that support wireless positioning.

The present invention may be employed with a multitude of applications and/or services, and may help to maintain power conservation in a wireless communication device.

### DESCRIPTION OF DRAWINGS

The invention will be further understood from the following detailed description of an exemplary embodiment, taken in conjunction with appended drawings, in which:

FIG. 1 discloses an exemplary short-range to long-range wireless communication scenario in accordance with at least one embodiment of the present invention.

FIG. 2 discloses a modular description of an exemplary wireless communication device usable with at least one embodiment of the present invention.

FIG. 3 discloses a structural description of the exemplary wireless communication device previously described in FIG. 2.

FIG. 4 discloses a flowchart describing a control process in accordance with at least one embodiment of the present invention.

### DESCRIPTION OF AN EXEMPLARY EMBODIMENT

While the invention has been described in terms of exemplary embodiments, various changes can be made therein without departing from the spirit and scope of the invention, as described in the appended claims.

### I. Wireless Communication Over Different Communication Networks

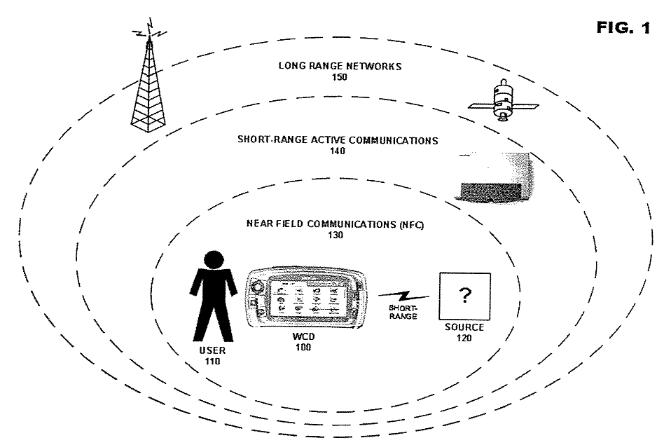

A WCD may both transmit and receive information over a wide array of wireless communication networks, each with different speed, range, quality (error correction), security (encoding), etc. characteristics. These characteristics will dictate the amount of information that may be transferred to a receiving device, and the duration of the information transfer. FIG. 1 includes a diagram of a WCD and how it interacts with various types of wireless networks.

In the example pictured in FIG. 1, user 110 possesses WCD 100. This device may be anything from a basic cellular handset to a more complex device such as a wirelessly enabled palmtop or laptop computer. Near Field Communications (NFC) 130 include various transponder-type interactions wherein normally only the scanning device requires its own power source. WCD 100 scans source 120 via short-range communication. A transponder in source 120 may use the energy and/or clock signal contained within the scanning signal, as in the case of RFID communication, to respond with data stored in the transponder. These types of technologies usually have an effective transmission range of a few inches to a few feet, and may be able to deliver stored data in amounts from 96 bits to over a megabit or 125 Kbytes relatively quickly. These characteristics make these technologies well suited for identification purposes, such as to receive an account number for a public transportation provider, a key code for an automatic door lock, an account number for a credit or debit transaction, etc.

The transmission range between two devices may be extended if both devices are capable of performing powered communications. Short-range active communications 140 includes devices wherein the sending and receiving devices are both active. An exemplary situation would include user 110 coming within effective transmission range of a Bluetooth™, WLAN, UWB, WUSB, etc. access point. In the case of Bluetooth™, a network may automatically be established to transmit information to WCD 100 possessed by user 10. This data may include information of an informative, educational or entertaining nature. The amount of information to be conveyed is unlimited, except that it must all be transferred in the time when user 110 is within effective transmission range of the access point. This duration is extremely limited if the user is, for example, strolling through a shopping mall or walking down a street. Due to the higher complexity of these networks, additional time is also required to establish the initial connection to WCD 100, which is extended if there are many devices queued for service in the transmission area. The transmission range of these networks depends on the technology, and may be from 32 ft. to over 300 ft. with additional power boosting.

Long-range networks 150 are used to give virtually uninterrupted coverage to WCD 100. Land-based repeaters or satellites are used to deliver communication coverage worldwide. While these systems are extremely functional, the use of these systems are often charged on a per-minute basis to user 110, with additional charges for data transfer, like wireless Internet access. Further, the regulations covering these systems cause additional overhead for both the users and providers, making the use of these systems more cumbersome.

### II. Wireless Communication Device

As previously described, the present invention may be utilized with a variety of wireless communication equipment. Therefore, it is also important to understand the communication tools available to user 110 before exploring the present invention. For example, in the case of a cellular telephone or other handheld wireless device, the integrated data handling capabilities play an important role in facilitating the transaction between the transmitting and receiving devices.

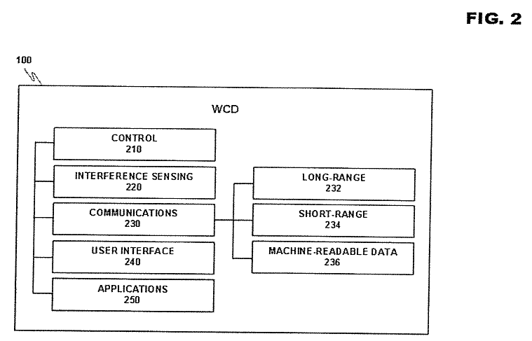

FIG. 2 discloses an exemplary modular layout for a wireless communication device usable with the present invention. WCD 100 is broken down into modules representing the functional aspects of the device. These functions may be performed by the various combinations of software and/or hardware components discussed below.

Control module 210 regulates the operation of the device. Inputs may be received from various other modules included within WCD 100. For example, interference sensing module 220 may use various techniques known in the art to sense sources of environmental interference within the effective transmission range of the wireless communication device. Control module 210 interprets these data inputs and in response may issue control commands to the other modules in WCD 100.

Communications module 230 incorporates all of the communications aspects of WCD 100. As shown in FIG. 2, communications module 230 includes, for example, long-range communications module 232, short-range communications module 234 and machine-readable data module 236. Communications module 230 utilizes at least these sub-modules to receive a multitude of different types of communication from both local and long distance sources, and to transmit data to recipient devices within the broadcast range of WCD 100. Communications module 230 may be triggered by control module 210 or by control resources local to the module responding to sensed messages, environmental influences and/or other devices in proximity to WCD 100.

User interface module 240 includes visual, audible and tactile elements which allow the user 110 to receive data from, and enter data into, the device. The data entered by user 110 may be interpreted by control module 210 to affect the behavior of WCD 100. User-inputted data may also be transmitted by communications module 230 to other devices within effective transmission range. Other devices in transmission range may also send information to WCD 100 via communications module 230, and control module 210 may cause this information to be transferred to user interface module 240 for presentment to the user.

Applications module 250 incorporates all other hardware and/or software applications on WCD 100. These applications may include sensors, interfaces, utilities, interpreters, data applications, etc., and may be invoked by control module 210 to read information provided by the various modules and in turn supply information to requesting modules in WCD 100.

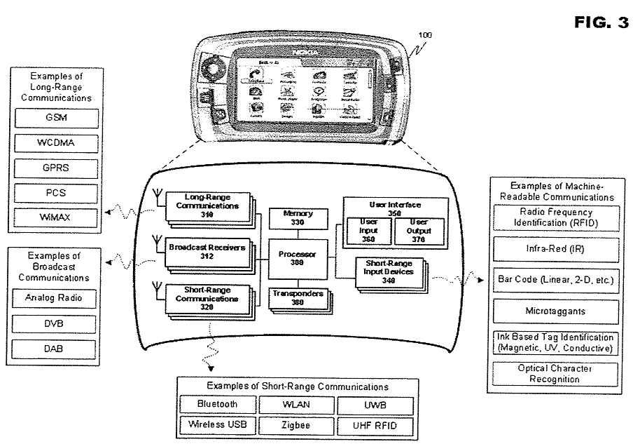

FIG. 3 discloses an exemplary structural layout of WCD 100 according to an embodiment of the present invention that may be used to implement the functionality of the modular system previously described in FIG. 2. Processor 300 controls overall device operation. As shown in FIG. 3, processor 300 is coupled to communications sections 310, 312, 320 and 340. Processor 300 may be implemented with one or more microprocessors that are each capable of executing software instructions stored in memory 330.

Memory 330 may include random access memory (RAM), read only memory (ROM), and/or flash memory, and stores information in the form of data and software components (also referred to herein as modules). The data stored by memory 330 may be associated with particular software components. In addition, this data may be associated with databases, such as a bookmark database or a business database for scheduling, email, etc.

Memory 330 may also encompass different forms of removable media that may be accessed by resources within WCD 100. A device such as WCD 100 may be configured to accept different forms of removable media, such as flash memory, CD-ROM, DVD-ROM, etc. Once coupled to, or inserted within, WCD 100, processor 300 may trigger a read/write device to access this removable media in order to load program information and/or other forms of data into memory integrated within WCD 100.

The software components stored by memory 330 include instructions that can be executed by processor 300. Various types of software components may be stored in memory 330. For instance, memory 330 may store software components that control the operation of communication sections 310, 312, 320 and 340. Memory 330 may also store software components including a firewall, a service guide manager, a bookmark database, user interface manager, and any communications utilities modules required to support WCD 100.

Long-range communications 310 performs functions related to the exchange of information over large geographic areas (such as cellular networks) via an antenna. These communication methods include technologies from the previously described 1G to 3G. In addition to basic voice communications (e.g., via GSM), long-range communications 310 may operate to establish data communications sessions, such as General Packet Radio Service (GPRS) sessions and/or Universal Mobile Telecommunications System (UMTS) sessions. Also, long-range communications 310 may operate to transmit and receive messages, such as short messaging service (SMS) messages and/or multimedia messaging service (MMS) messages. As disclosed in FIG. 3, Long-range communications 310 may be composed of one or more subsystems supporting various long-range communications mediums. These subsystems may, for example, be radio modems enabled for various types of long-range wireless communication.

As a subset of long-range communications 310, or alternatively operating as an independent module separately connected to processor 300, broadcast receivers 312 allows WCD 100 to receive transmission messages via mediums such as Analog Radio, Digital Video Broadcast for Handheld Devices (DVB-H), Digital Audio Broadcasting (DAB), etc. These transmissions may be encoded so that only certain designated receiving devices may access the transmission content, and may contain text, audio or video information. In at least one example, WCD 100 may receive these transmissions and use information contained within the transmission signal to determine if the device is permitted to view the received content. As in the case of long-range communications 310, broadcast receivers 312 may be comprised of one or more radio modems utilized to receive a variety of broadcast information.

Short-range communications 320 is responsible for functions involving the exchange of information across short-range wireless networks. As described above and depicted in FIG. 3, examples of such short-range communications 320 are not limited to Bluetooth™, WLAN, UWB, Zigbee, UHF RFID, and Wireless USB connections. Accordingly, short-range communications 320 performs functions related to the establishment of short-range connections, as well as processing related to the transmission and reception of information via such connections. Short-range communications 320 may be composed of one or more subsystems made up of, for example, various radio modems employed to communicate via the previously indicated assortment of short range wireless mediums.

Short-range input device 340, also depicted in FIG. 3, may provide functionality related to the short-range scanning of machine-readable data (e.g., for NFC). For example, processor 300 may control short-range input device 340 to generate RF signals for activating an RFID transponder, and may in turn control the reception of signals from an RFID transponder. Other short-range scanning methods for reading machine-readable data that may be supported by the short-range input device 340 are not limited to IR communications, linear and 2-D (e.g., QR) bar code readers (including processes related to interpreting UPC labels), and optical character recognition devices for reading magnetic, UV, conductive or other types of coded data that may be provided in a tag using suitable ink. In order for the short-range input device 340 to scan the aforementioned types of machine-readable data, the input device may include a multitude of optical detectors, magnetic detectors, CCDs or other sensors known in the art for interpreting machine-readable information.

As further shown in FIG. 3, user interface 350 is also coupled to processor 300. User interface 350 facilitates the exchange of information with a user. FIG. 3 shows that user interface 350 includes a user input 360 and a user output 370. User input 360 may include one or more components that allow a user to input information. Examples of such components include keypads, touch screens, and microphones. User output 370 allows a user to receive information from the device. Thus, user output portion 370 may include various components, such as a display, light emitting diodes (LED), tactile emitters and one or more audio speakers. Exemplary displays include liquid crystal displays (LCDs), and other video displays.

WCD 100 may also include one or more transponders 380. This is essentially a passive device that may be programmed by processor 300 with information to be delivered in response to a scan from an outside source. For example, an RFID scanner mounted in a entryway may continuously emit radio frequency waves. When a person with a device containing transponder 380 walks through the door, the transponder is energized and may respond with information identifying the device, the person, etc.

Hardware corresponding to communications sections 310, 312, 320 and 340 provide for the transmission and reception of signals. Accordingly, these portions may include components (e.g., electronics) that perform functions, such as modulation, demodulation, amplification, and filtering. These portions may be locally controlled, or controlled by processor 300 in accordance with software communications components stored in memory 330.

The elements shown in FIG. 3 may be constituted and coupled according to various techniques in order to produce the functionality described in FIG. 2. One such technique involves coupling separate hardware components corresponding to processor 300, communications sections 310, 312 and 320, memory 330, short-range input device 340, user interface 350, transponder 380, etc. through one or more bus interfaces. Alternatively, any and/or all of the individual components may be replaced by an integrated circuit in the form of a programmable logic device, gate array, ASIC, multi-chip module, etc. programmed to replicate the functions of the stand-alone devices. In addition, each of these components is coupled to a power source, such as a removable and/or rechargeable battery (not shown).

The user interface 350 may interact with a communications utilities software component, also contained in memory 330, which provides for the establishment of service sessions using long-range communications 310 and/or short-range communications 320. The communications utilities component may include various routines that allow the reception of services from remote devices according to mediums such as the Wireless Application Protocol (WAP), Hypertext Markup Language (HTML) variants like Compact HTML (CHTML), etc.

### III. Exemplary Operation of a Wireless Communication Device

Radio based positioning applications may scan and detect radio beacons/stations (WLAN, Bluetooth, RFID, Wibree, etc.) and calculate the position of the WCD 100. In radio based positioning applications, the scanning frequency is the rate (e.g., every minute) at which the scanning of fixed radio beacons/stations is performed. A cell is the smallest geographic area covered by a base station in the mobile network, such as in the case of a long-range cellular network like GSM, and these cells may function together to make up the entire network. In at least one example of the present invention, WCD 100 may directly connect to a network cell (e.g., to a base station using long-range wireless communication), or alternatively, may connect to the network using short-range wireless communication to local radio beacons/stations. A Cell ID is identification information of the cell in which the WCD 100 is located. As the WCD 100 moves through different cells, it leaves one cell and joins another which may change the serving Cell ID which is the connection point information that may be stored and used by WCD 100. Alternatively, the WCD 100 may connect with WLAN or WiFi access points or beacons whose IP address or MAC address may be obtained as the connection point information.

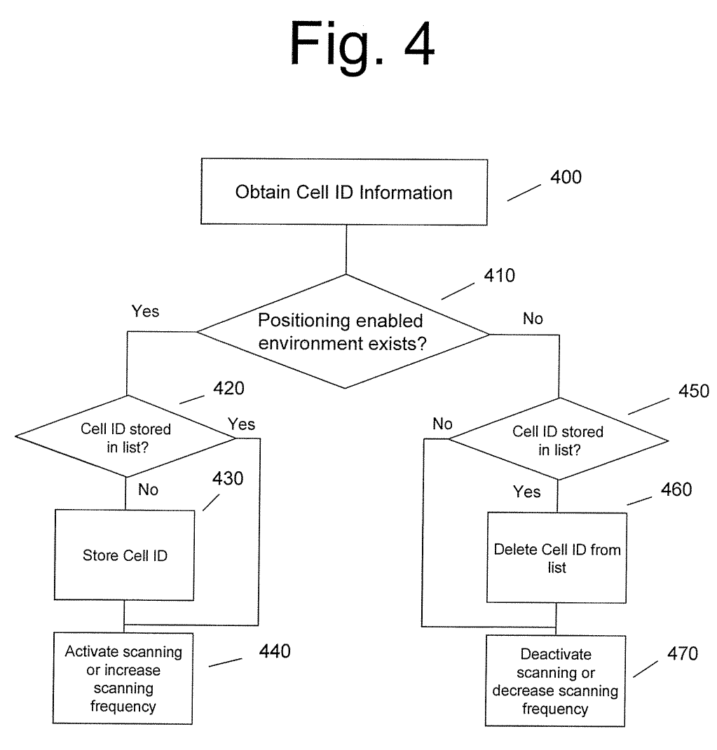

Currently, when a user (and WCD) leaves a positioning-enabled environment, an active radio-based wireless positioning application either needs to be manually switched off or it will continue to execute. If left running, the application will continually scan for signals from radio beacons/stations, but will not compute a position determination because it will not receive any usable information. As a result, WCD power consumption will be unnecessarily high and the battery will be depleted faster than had the application been switched off. If the application is manually switched off when the user leaves the positioning-enabled environment, it would need to be manually reactivated when the user is again near a positioning-enabled environment. This results in a frustrating user experience and may be forgotten most of the time. The present invention, in accordance with at least one embodiment, as described in the description of FIG. 4 below, alleviates the need to manually activate and deactivate the radio based positioning application and as a result reduces power consumption and improves user experience.

FIG. 4 discloses an exemplary flow chart in accordance with at least one embodiment of the present invention. In step 400, WCD 100 may obtain the connection point information of the environment in which the WCD 100 is currently located. The connection point information may be obtained by a variety of inputs and/or sensors in the WCD 100. After the connection point information is obtained, processor 300 may determine if a positioning-enabled environment exists (step 410) based at least on the connection point information. If a positioning-enabled environment exists, in step 420 processor 300 may further determine if the connection point information has been previously stored in a list. If the connection point information has not been previously stored in the list, processor 300, in step 430 may store the connection point information in a list in memory 330. The list may contain at least connection point information and whether a positioning-enabled environment exists in the environment corresponding to the connection point information. After the connection point information is stored in the list or if it is determined in step 420 that the connection point information has previously been stored in the list, processor 300, in step 440 may activate the scanning of radio beacons/stations. Alternatively, if scanning is already active, processor 300 may increase the scanning frequency of the radio based positioning application.

If processor 300 determines in step 410 that a positioning-enabled environment does not exist, processor 300 may determine in step 450 if the connection point information has been previously stored in the list. If the connection point information has been previously stored in the list, processor 300, in step 460 may delete the connection point information from the list. After the connection point information is deleted from the list, or if it is determined in step 450 that the connection point information was not previously stored in the list, processor 300 may deactivate the scanning of radio beacons/stations or decrease the scanning frequency of the radio based positioning application in step 470.

In at least one example of the present invention, WCD 100 may, as a result of the sensed conditions, activate or deactivate various hardware resources (e.g., resources associated with scanning) and/or software applications. If the WCD 100 is in a positioning-enabled environment, e.g. work, shopping mall, airport, it may perform scans regularly, e.g. every minute, and automatically calculate the position of the WCD 100. However, when the WCD 100 leaves the positioning-enabled environment, the connection point information of the WCD 100 may change. If the new connection point information does not cover a positioning-enabled environment, this change in connection point information may trigger the deactivation or reduction of the scanning frequency of the radio based positioning application. This deactivation or reduction of scanning reduces power consumption in environments which are not positioning-enabled. The scanning may be reactivated when connection point information is detected which has been identified to be within a positioning-enabled environment. The definition of connection points that cover environments which offer indoor positioning may be done automatically by a “learning” algorithm within the radio based positioning application. The learning algorithm may store information pertaining to all connection points that are determined to cover positioning-enabled environments.

For instance, when a user leaves a building which offers indoor positioning (i.e., is a positioning-enabled environment), the connection point information of the WCD 100 may change. This change in the connection point information, if determined to not cover a positioning-enabled environment, may cause a deactivation of scanning or reduction of scanning frequency in the WCD 100. When the user is again near a positioning-enabled environment, the change in the connection point information may cause activation of scanning or an increase in the scanning frequency in the WCD 100. The change in the connection point information may also be used to control other applications that may be location dependent such as calling supported by Voice over Internet protocol (VoIP), call/mail forwarding, etc. In an example scenario, VOIP may be automatically employed when entering a building which offers indoor positioning to conserve cellular minutes. However, upon leaving the building, the change in the connection point information may deactivate VOIP and cause the WCD 100 to rely on cellular service. In accordance with at least one embodiment of the present invention, GPS information may also be employed to trigger the activation or deactivation of scanning or to control the scanning frequency of the radio based positioning application.

The present invention, in accordance with at least one embodiment, may reduce power consumption and improve user experience by automatically activating or increasing the scanning frequency of a radio based positioning application when the WCD 100 is in, or near, a positioning-enabled environment, and by automatically deactivating or decreasing the scanning frequency of the radio based positioning application when the WCD 100 leaves a positioning-enabled environment. The connection point information of position enabled environments may be stored in a list which may be used to automatically control the behavior of the device thus, reducing power consumption and improving user experience.

Accordingly, it will be apparent to persons skilled in the relevant art that various changes in forma and detail can be made therein without departing from the spirit and scope of the invention. The breadth and scope of the present invention should not be limited by any of the above-described exemplary embodiments, but should be defined only in accordance with the following claims and their equivalents.

1. A method, comprising:
obtaining connection point information;
determining if a positioning-enabled environment exists based on at least the connection point information;
storing the connection point information in a wireless communication device if a positioning-enabled environment exists; and
controlling scanning in the wireless communication device based on at least the stored information.

2. The method according to claim 1, wherein storing the connection point information includes storing at least some of the connection point information in a list on the wireless communication device.

3. The method according to claim 2, wherein at least some connection point information previously stored in the list is deleted if it is determined that a positioning-enabled environment does not exist.

4. The method according to claim 1, wherein the controlling step activates the scanning if the connection point information is stored in the wireless communication device and deactivates the scanning if the connection point information is not stored in the wireless communication device.

5. The method according to claim 1, wherein the controlling step increases a scanning frequency if the connection point information is stored in the wireless communication device and decreases a scanning frequency if the connection point information is not stored in the wireless communication device.

6. The method according to claim 1, wherein the connection point information includes at least one of:
cell identification information;
IP address; and
MAC address.

7. A wireless communication device, comprising:
at least one communication module configured to obtain connection point information;
at least one processing module configured to determine if a positioning-enabled environment exists based on at least the connection point information;
at least one memory module configured to store the connection point information in a wireless communication device if a positioning-enabled environment exists; and
at least one processing module configured to control scanning in the wireless communication device based on at least the stored information.

8. The device according to claim 7, wherein said memory module stores at least some of the connection point information in a list on the wireless communication device.

9. The device according to claim 8, wherein at least some connection point information previously stored in the list is deleted if it is determined that a positioning-enabled environment does not exist.

10. The device according to claim 7, wherein the processing module activates the scanning if the connection point information is stored in the wireless communication device and deactivates the scanning if the connection point information is not stored in the wireless communication device.

11. The device according to claim 7, wherein the processing module increases a scanning frequency if the connection point information is stored in the wireless communication device and decreases a scanning frequency if the connection point information is not stored in the wireless communication device.

12. The device according to claim 7, wherein the connection point information includes at least one of:
cell identification information;
IP address; and
MAC address.

13. A wireless communication device, comprising:
means for obtaining connection point information;
means for determining if a positioning-enabled environment exists based on at least the connection point information;
means for storing the connection point information in a wireless communication device if a positioning-enabled environment exists; and
means for controlling scanning in the wireless communication device based on at least the stored information.

14. The device according to claim 13, wherein said storing means stores at least some of the connection point information in a list on the wireless communication device.

15. The device according to claim 14, wherein at least some connection point information previously stored in the list is deleted if it is determined that a positioning-enabled environment does not exist.

16. The device according to claim 13, wherein controlling means activates the scanning if the connection point information is stored in the wireless communication device and deactivates the scanning if the connection point information is not stored in the wireless communication device.

17. The device according to claim 13, wherein the controlling means increases a scanning frequency if the connection point information is stored in the wireless communication device and decreases a scanning frequency if the connection point information is not stored in the wireless communication device.

18. The device according to claim 13, wherein the connection point information includes at least one of:
cell identification information;
IP address; and
MAC address.

19. A computer program product comprising a computer usable medium having computer readable program code embodied in said medium, comprising:
a computer readable program code configured to obtain connection point information;
a computer readable program code configured to determine if a positioning-enabled environment exists based on at least the connection point information;
a computer readable program code configured to store the connection point information in a wireless communication device if a positioning-enabled environment exists; and
a computer readable program code configured to control scanning in the wireless communication device based on at least the stored information.

20. The computer program product of claim 19, wherein storing the connection point information includes storing at least some of the connection point information in a list on the wireless communication device.

21. The computer program product of claim 20, wherein at least some connection point information previously stored in the list is deleted if it is determined that a positioning-enabled environment does not exist.

22. The computer program product of claim 19, wherein the program code for controlling activates the scanning if the connection point information is stored in the wireless communication device and deactivates the scanning if the connection point information is not stored in the wireless communication device.

23. The computer program product of claim 19, wherein the program code for controlling increases a scanning frequency if the connection point information is stored in the wireless communication device and decreases a scanning frequency if the connection point information is not stored in the wireless communication device.

24. The computer program product of claim 19, wherein the connection point information includes at least one of:
cell identification information;
IP address; and
MAC address.

25. A system, comprising:
a wireless communication device, the wireless communication device including at least a position determination application; and
at least one beacon;
the wireless communication device obtaining connection point information from the at least one beacon;
the wireless communication device further determining if a positioning-enabled environment exists based on at least the connection point information;
the wireless communication device further storing the connection point information if a positioning-enabled environment exists; and
the wireless communication device controlling scanning for the position determination application based on at least the stored information.
